(19) United States
(12) Patent Application Publication
(10) Pub. No.: US 2013/0013444 A1
(43) Pub. Date: Jan. 10, 2013

(54) Service Selection for Reduced Composition Cost

(75) Inventors: Konstantinos Vandikas, Solna (SE); Roman Levenshteyn, Aachen (DE)

(73) Assignee: Telefonaktiebolaget L M Ericsson (publ), Stockholm (SE)

(21) Appl. No.: 13/517,059

(22) PCT Filed: Dec. 23, 2009
(86) PCT No.: PCT/EP2009/009245

§ 371 Date: Sep. 19, 2012

(51) Int. Cl. G06Q 30/00

(52) U.S. Cl. 705/26.5

(57) ABSTRACT

It is described a concept for a service selection of at least two services of a composite service wherein a composite service description (100) of the composite service includes at least two service templates (102a, 102b, 102c), each of which defines at least one constraint for a service wherein the service is to be executed in place of the service template to thereby constitute part of the composite service. From service database there is selected for each service template a corresponding candidate set comprising at least one service matching the at least one constraint of the service template. Subsequently or at least partially simultaneously for each of the at least two service templates (102a, 102b, 102c), from the corresponding candidate set one service is selected so as to provide, based on a predetermined cost metric, for a reduced composition cost. The predetermined cost metric may include a latency metric, an energy efficiency metric, a co-location metric or a traffic metric, etc.

### FIELD OF THE INVENTION

The present invention relates to the field of service selection of services of a composite service.

### BACKGROUND OF THE INVENTION

Service composition refers to a technology, where so-called composite services (sometimes called composite applications) are dynamically built by combining constituent services. The selection of the constituent services as components of the composite service may be performed just in time at user request. The needed constituent services are described in terms of required generic constraints or properties. Any service that matches the needed constraints can be used as part of the composition service. Rather than fixed binding of a particular service, and any suitable service within a pool of available services can be selected. The pool of available constituent services can change dynamically by adding new services and/or by removing services from the pool. A composite service can therefore consist of different constituent services at each invocation. Thus, the set of services that are actually included into a composite service may not be static, but may depend on runtime conditions. The constituent services do not need to be specifically designed for service composition. They can be integrated into a composite device but they can also work as a single device.

WO 2008/119364 A1 relates to a technique for creating, modifying and executing composite services in a telecommunication network. In a method of realization, the execution of composite services is triggered in a four-step procedure.

In a first step, a trigger event is received. The trigger event requests an execution of a composite service relating to at least one telecommunication session for a user of the telecommunication network. In a second step, a skeleton of the requested composite service is received. The received skeleton specifies a service pattern logically linking a plurality of service references. In a next step, the skeleton is analyzed during runtime to determine constituting services that are to form the composite service, as well as an execution workflow for the constituting services. Execution of the determined constituting services in accordance with the determined execution workflow is triggered in a fourth step.

The selection of a particular service is usually followed by invocation of the selected service. Accordingly, in known service composition systems each step of a composite service description is executed independently of any other steps.

There may be a need for an improved technique for the selection of services of a composite service.

### SUMMARY OF THE INVENTION

This need may be met by the subject-matter according to the independent claims. Advantageous embodiments of the herein disclosed subject-matter are described by the dependent claims.

According to a first aspect of the invention, there is provided a method for service selection of at least two services of a composite service. The method comprises (a) providing a composite service description which includes at least two service templates. Each service template of the composite service description defines at least one constraint for a service wherein the service is to be executed in place of the service template to thereby constitute part of the composite service. The method further comprises (b) selecting from a service database for each service template a corresponding candidate set comprising at least one at least one service that matches the at least one constraint of the service template, and (c) for each of the at least two service templates, selecting from the corresponding candidate set one service so as to provide, based on a predetermined cost metric, for a reduced composition cost.

The described method is based on the idea that by first selecting for each service template a corresponding candidate set of services and selecting from the corresponding candidate set one service, wherein the selection is based on a predetermined cost metric, the service selection may be improved by not taking into account only one candidate set for selection of a service out of the candidate set, but rather by taking into account the services of at least two candidate sets for selection of a candidate out of one of the at least two candidate sets.

A composite service description generally consists of multiple steps. Some of the steps are called service templates. The service templates describe by means of constraints what services can be invoked at this step at runtime. There can be more than one service matching the constraints in the service template. In this case, the system is free to take any of the matching services at runtime. The process of finding a matching service according to the service template is called service selection. Composite service description as used herein denotes the entirety or part of a composite service description of a composite service. For example, in an embodiment, not the entire service description of a complete composite service is provided for service selection. Rather, according to an embodiment only part of the entire service description is provided, or, according to another embodiment, only the at least two service templates are provided.

According to an embodiment, the composite service description includes the at least two service templates and, optionally, comprises further code or parameters that are necessary for execution of the composite service.

Generally herein, the term service should be understood in a broad sense. For example, a service can be any executable program code. The program code may be executable in any appropriate form, and may be e.g. in the form of a compiled program code, an interpretable program code, etc. Further, the service may include configuration options or other data that is necessary for execution of the service.

According to an embodiment, the service database is a storage having stored therein information related to available services that allows for selection of a service matching the at least one constraint of a respective service template. According to a further embodiment, the service database stores and provides to information about the constituent services available for composition. This information about services may include:
Formal service description (e.g. based on web services description language WSDL, web application description language WADL, etc.)
Descriptions of parameter names, types, return values
Service type (e.g. session initiation protocol uniform SIP, Web Service, etc.)
Service availability (e.g. online, offline, available, unavailable, etc.)
Service Endpoint (e.g. uniform resource locator URL, SIP unified resource identifier URI, etc.)

Service selection can be e.g. realized by evaluating the constraints against the current state of the service database and thus obtaining a set of matching constituent service descriptions, fulfilling the constraints. Depending on the specificity of the constraint, such a set may contain more than one element. E.g. for in case of constraint (e.g. service.support=InstantMessaging) the result set may contain service descriptions of services for sending, such as short message service (SMS), multimedia messaging service (MMS), session initiation protocol instant messaging (SIP IM), ICQ instant messaging (ICQ IM), etc.

According to an embodiment, the predetermined cost metric may be any cost metric or combination of cost metrics that may be used for selection of a service out of a candidate set of services. It should be mentioned, that cost is meant in the mathematical sense of the word as a measure of something and is not, at least not necessarily, a monetary cost.

According to an embodiment, the reduced composition cost is the cost for composing the selected services of the at least two service templates, wherein the reduced composition cost for the selected services is lower than a composition cost of at least one other selection of services for the at least two service templates.

According to a further embodiment, the selection of candidate sets for the at least two service templates is finished before the selection of services from one of the candidate set is performed.

According to a further embodiment, the one service, that is selected out of the corresponding candidate set, is selected so as to provide a minimum of the composition cost for composing the composite service. According to another embodiment, the one service which is selected out of the corresponding candidate set is selected so as to provide a minimum of the composition cost for composing the at least two service templates of the composite service. Herein, according to an embodiment the minimum of the composition cost is an absolute minimum of the composition cost. According to an embodiment, such an absolute minimum of the composition cost may be obtained by evaluating all possible combinations of services among the at least two candidate sets. Depending on the number of service templates (hence the number of candidate sets) and the number of services within the candidate sets, this may require a large computation effort. Further, the computation effort may be different for different cost metrics, i.e may be dependent on the cost metric used.

According to other embodiments, the minimum of the composition cost for composing composing the at least two selected services may be a local minimum of the composition cost.

According to an embodiment, selecting from each corresponding candidate set one component for each of the at least two component templates comprises (i) calculating the overall composition cost for every combination of components allowed by the at least two component templates and (ii) selecting the combination of components with the lowest overall composition cost.

According to an embodiment, the composition cost for composing the composite service is calculated by taking into account the selected services for the entirety of service templates of the composite service description. In other words, if the composite service description includes a number of n service templates the cost for composing the composite service is calculated by taking into account the selected services for all n service templates. It should be mentioned that according to an embodiment, the at least two service templates for which a corresponding candidate set is selected from the service database may correspond to the number n of the entirety of service templates in the composite service description. In other embodiments, a number m of service templates out of the n service templates of the composite service description, where m is smaller than n (m<n), is taken into account for selecting a corresponding candidate set from the service database.

According to another embodiment, the composition cost for composing the composite service is calculated by taking into account the selected services for a subset of the entirety of service templates of the composite service description. For example, according to an embodiment only a predetermined number of service templates may be taken into account for calculating the composition cost for composing the composite service. According to an embodiment, the composition cost for composing the composite service is calculated by taking into account selected services for the service template which follows next in the execution of the composite service and the subsequent service template, just to name an example.

According to a further embodiment, selection of the corresponding candidate set is performed before invocation of composing the composite service, i.e. before starting a service composition session. For example, according to an embodiment where the composite service description (skeleton) does not use dynamic control flow modifications (e.g. aspect orientated programming, AOP) or service constraints depending on dynamic data, the “static” composite service description/skeleton may be analyzed before the composite service is executed.

According to an embodiment, additional information about the context in which a composite service is to be executed is used for selection of a service out of the candidate set, i.e. such additional information is taken into account in some embodiments of cost metrics.

Even if the analysis of the composite service description is not possible for all of the service templates, according to an embodiment the selection of the corresponding candidate set is performed for at least part of the at least two service templates before invocation of composing the composite service. According to another embodiment, selection of at least one of the corresponding candidate sets of the at least two service templates is performed at least in part on or after invocation of composing the composite service. For example, if a service template defines a constraint which depends on dynamic data, selection of the corresponding candidate set of the service template is performed after invocation of composing the composite service, and, according to an embodiment, after invocation of the composite service itself, so that the dynamic data on which the constraint depends is available.

However, it should be understood that the time of selection of the corresponding candidate set for a service template may additionally or alternatively depend on other factors. For example, as mentioned above analysis of the composite service description may be performed statically, before the composition session starts. However, this assumes that the content of the service database does not change before or during a composition session, as such a change may alter the result of the analysis. Further, in case that the analysis of the composite service description is performed at runtime of a composition session, the selection of a corresponding candidate set for a service template may additionally take into account the service about concrete constituent services that have been already selected for execution.

Generally, a cost metric may take into account at least one of (a) information about a composition session; (b) an analysis of constituent services participating in a composition session; (c) context information about the context in which the composition is to be executed. The method according to the first aspect may include estimating the cost of composition for each particular combination of concrete services that may be selected for the service templates, i.e. that match the constraints of the service template. The cost estimate is based on a certain metric or combination of multiple metrics, some of which are exemplarily discussed in greater detail in the following.

According to an embodiment, the predetermined metric comprises a latency metric according to which the cost of composing of selected services is dependent on the latency for composing the selected services of the at least two service templates. Herein, the latency is defined as time delay between the invocation of composing the services of the at least two service templates and the earliest possible execution of the composite service. For example, according to an embodiment, of a latency metric the cost of composing selected services is the higher, the larger the latency is for composing the selected services.

According to another embodiment, the predetermined metric comprises an energy efficiency metric according to which the cost of composing of selected services is the lower, the less energy consumption is involved with the selected services of the at least two service templates. According to an embodiment, the energy consumption which is involved with the selected services includes the energy consumption of the execution of the selected services. According to another embodiment, the energy consumption involved with the selected services includes the energy consumption for composing the selected services to the composite service.

According to another embodiment, the predetermined metric comprises a co-location metric according to which the cost for composing of selected services is dependent on the number of the selected services which are located on the same network node. Hence, examples of a co-location metric may take into account the fact that composing of the composite service involves more traffic between network nodes if the selected services are distributed over a plurality of network nodes, compared to a situation where the selected services or at least part of the selected services are located on the same network node.

According to a further embodiment, the predetermined metric comprises a traffic metric according to which the cost of composing of selected services is dependent on the amount of data that is exchanged between different communication network nodes for composing the services of the at least two service templates. For example, according to an embodiment the cost of composing of selected services is the higher the higher is the amount of data that is exchanged between different communication network nodes for composing the services of the at least two service templates.

According to a further embodiment, the at least two service templates include a first service template and a second service template, wherein selecting of service for the first service template includes selecting this service depending on the selection of a service for the second service template and wherein the selected service for the second template is scheduled for being executed after the selected service of the first service template. Scheduling of the service templates may be defined in the composite service description in one embodiment. However, scheduling may be defined otherwise. In other words, selecting of a service of the first service template takes into account the selection of a service for another service template that is executed subsequently and hence selections for future services are taken into account in one embodiment.

According to a second aspect of the herein disclosed subject-matter, a selection entity for service selection of at least two services of a composite service is provided. The selection entity comprises (a) a receive unit for retrieving, from a composite service description storage, a composite service description which includes at least two service templates. Each service template defines at least one constraint for a service wherein the service is to be executed in place of the service template to thereby constitute part of the composite service. In other words, according to an embodiment the service template defines a sort of a placeholder for a service and once a particular service is selected (and executed at a time) in place of the service template, this selected service constitutes part of the composite service.

Further, the selection entity comprises a candidate selection unit for selecting, from a service database, for each service template a corresponding candidate set comprising at least one service, wherein the at least one service of each candidate set matches the at least one constraint of the corresponding service template. Further, the selection entity comprises a service selection unit for selecting from a corresponding candidate set, for each of the at least two service templates, one service so as to provide, based on a predetermined cost metric, for a reduced composition cost.

According to an embodiment, the selection entity is provided in the form of a network node of a communication network, e.g. of a telecommunication network.

According to a further embodiment, the selection entity further comprises a sending unit for sending one of “the services selected from the candidate sets” and “identifiers of the services selected from the candidate sets” to a further network node of the communication network. For example, according to an embodiment, if the further network node of the communication network is an entity on which the composite service or at least the at least two services of the composite service is to be executed, in one embodiment the selected services itself are sent to the further network node. According to another embodiment, e.g. where the further network node is configured for further processing of the services selected from the candidate sets, identifiers of the services selected from the candidate sets are sent to the further network node. The further network node then may forward the identifiers of the services selected from the candidate sets or itself may retrieve or download the services corresponding to the identifiers.

According to an embodiment, the network node of the communication network which comprises the sending unit may be any entity of a communication network, e.g. a central entity of the communication network which is responsible for the orchestration of composed services.

According to an embodiment, the composite service description storage may be a remote storage or a local storage configured for storing or having stored therein at least one composite service description. Further, the service database may be a remote service database or a local service database.

Generally herein, the further network node which is configured for receiving the services selected from the candidate set or for receiving the identifiers of the services selected from the candidate sets may be any type of communication end device which is capable of connecting with the communication network.

According to an embodiment, the communication network may be any type of telecommunication network, such as the Internet or a cellular network. For example, according to an embodiment, a communication of the further network node with the communication network may be established via a wireless radio transmission link. Further, according to an embodiment the further network node is an embedded device or a user equipment (UE) such as a cellular mobile phone, a personal digital assistant (PDA), a notebook computer or any other movable communication end device.

According to a third aspect of the herein disclosed subject-matter, a computer-readable medium is provided. On the computer-readable medium there is stored a computer program for service selection of at least two services of a composite service, the computer program, when being executed by a data processor, is adapted for controlling or for carrying out the method as set forth in the first aspect or an embodiment thereof.

The computer-readable medium may be readable by a computer or by a processor. The computer-readable medium may be, for example but not limited to, an electric, magnetic, optical, infrared or semiconductor system, device or transmission medium. The computer-readable medium may include at least one of the following media: a computer-distributable medium, a program storage medium, a record medium, a computer-readable memory, a random access memory, an erasable programmable read-only memory, a computer-readable software distribution package, a computer-readable signal, a computer-readable telecommunications signal, computer-readable printed matter, and a computer-readable compressed software package.

According to a fourth aspect of the herein disclosed subject-matter, a program element for service selection of at least two services of a composite service is provided. The program element, when being executed by a data processor, is adapted for controlling or for carrying out the method as set forth in the first aspect or an embodiment thereof.

The program element may be implemented as computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The program element may be available from a network, such as the World Wide Web, from which it may be downloaded.

In the following, there will be described exemplary embodiments of the subject-matter disclosed herein with reference to a method for service selection of at least two services of a composite service and a selection entity for a service selection. It has to be pointed out that of course any combination of features relating to different aspects of the herein disclosed subject-matter is also possible. In particular, some embodiments have been described with reference to apparatus type claims whereas other embodiments have been described with reference to method type claims, with reference to claims relating to a computer-readable medium or with reference to claims relating to a program element. However, a person skilled in the art will gather from the above and the following description that, unless otherwise notified, in addition to any combination of features belonging to one aspect also any combination between features relating to different aspects or embodiments, for example even between features of the apparatus type claims and features of method type claims, as well as features relating to a computer-readable medium and features relating to a program element is considered to be disclosed with this application.

The aspects and embodiments defined above and further aspects and embodiments of the herein disclosed subject-matter are apparent from the examples to be described hereinafter and which are explained with reference to the drawings but to which the invention is not limited.

### BRIEF DESCRIPTION OF THE FIGURES

FIG. 1 illustrates a method for service selection of at least two services of a composite service in accordance with embodiments of the herein disclosed subject-matter.

FIG. 2 illustrates a further method for service selection of at least two services of a composite service in accordance with embodiments of the herein disclosed subject-matter.

FIG. 3 shows a telecommunication network employing a method for service selection in accordance with embodiments of the herein disclosed subject-matter.

### DETAILED DESCRIPTION OF THE INVENTION

The illustration in the drawings is schematic. It is noted that in different figures similar or identical elements are provided with the same reference signs or with reference signs which are different from the corresponding reference signs only within the first digit or an appended character.

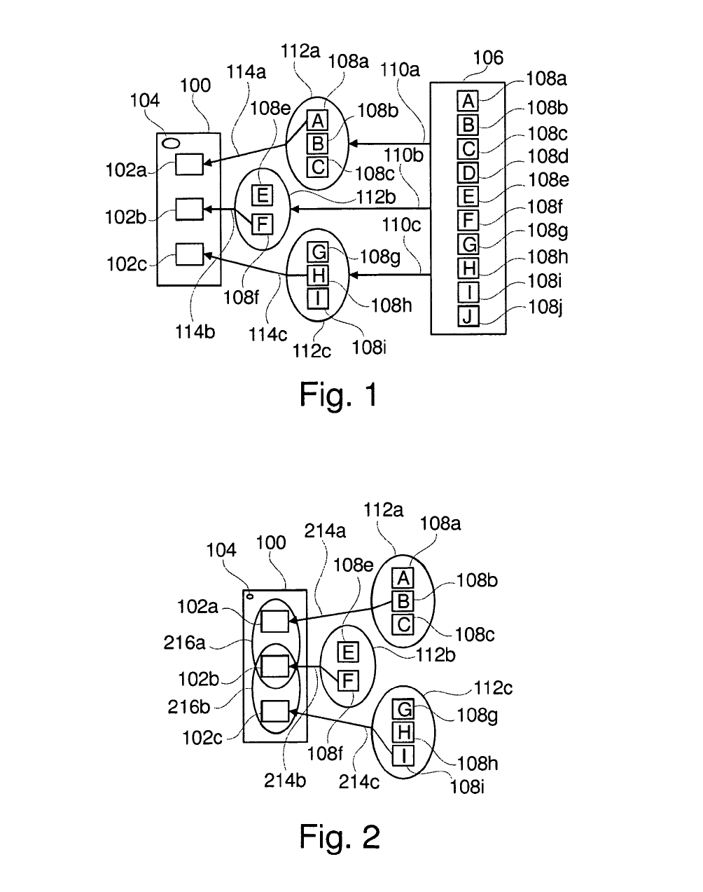

FIG. 1 illustrates a method for service selection of at least two services for a composite service, the method being in accordance with embodiments of the herein disclosed subject-matter.

o Indicated at 100 in FIG. 1 is a composite service description (also referred to herein as skeleton). The composite service description 100 comprises three service templates 102a, 102b, 102c. Each service template defines at least one constraint for a service which is to be executed in place of the service template to thereby constitute part of the composite service which is described by the composite service description 100. Exemplarily shown in FIG. 1 is further data 104 of the skeleton 100. The further data 104 may be for example parameters, e.g. parameters which are referenced by a service which is executed in place of one of the service templates 102a, 102b, 102c. Further shown in FIG. 1 is a service database 106 comprising a plurality of available services 108a, 108b, . . . 108j, hereinafter referred to for short as 108a-j. The method for service selection according to embodiments of the herein disclosed subject-matter comprises selecting, indicated at 110a, 110b, 110c in FIG. 1, from the service database 106 for each service template 102a, 102b, 102c a corresponding candidate set 112a, 112b, 112c. Each candidate set comprises at least one service matching the at least one constraint of the corresponding service template. In particular, a first candidate set 112a for the first service template 102a comprises services 108a, 108b, 108c. Further, a second candidate set 112b for a second service template 102b comprises services 108e and 108f which match the at least one constraint of the second service template 102b. Further, a third candidate set 112c comprises services 108g, 108h and 108i which match the at least one constraint of a third service template 102c. It should be understood that the elements 108a-j of FIG. 1, which represent the respective services, are in one embodiment the services themselves. According to other embodiments, the elements 108a-j represent identifiers of the respective services.

In accordance with embodiments of the herein disclosed subject-matter, for each of the three service templates 102a, 102b, 102c from the corresponding candidate set 112a, 112b, 112c a concrete candidate/concrete service is selected so as to provide, based on a predetermined cost metric, for a reduced composition cost. In particular, from the first candidate set 112a the service 108a is selected, indicated at 114a, to be executed in place of the service template 102b. In this sense, it should be understood that selection of a service to be executed in place of a service template does not already include the execution of the service. Rather it is emphasized that the selected service is selected for a specific purpose, namely to be executed in place of the corresponding service template.

Further, it should be noted that selection of a service to be executed in place of a service template does not necessarily include the transfer of the service or an identifier of the service between entities or units of the system. Rather, according to an embodiment selection of a service corresponds to identifying the respective service for the desired purpose, namely for being executed in place of the corresponding service template.

Having now regard to the second candidate set 112b, it is shown in FIG. 1 that out of the second candidate set 112b the service 108f is selected for being executed in place of the second service template 102b. The selection of the service 108f is indicated at 114b in FIG. 1.

Out of the third candidate set 112c, the service 108h is selected, indicated at 114c in FIG. 1, to be executed in place of the third service template 102c.

As a result of the above-described service selection method, there are identified services 108a, 108f and 108h to be executed in place of the service templates 102a, 102b, 102c, respectively. Identifying the services which are to be executed in place of the service templates provides the information necessary to compose the composite service which is defined by the skeleton 100.

According to an embodiment the method for service selection comprises the step of composing the composite service. As generally described herein, composing of the composite service may be performed subsequently to selecting the concrete services for the service templates. According to other embodiments, selecting of the concrete services to be executed in place of the service templates is at least partially performed simultaneously with composing of the composite service. For example, in cases where the database 106 changes (or may change) during runtime of the composite service and/or composition time of the composite service, or if service constraints depend on dynamic data, or if the skeleton 100 uses dynamic control flow modifications, selection of a service for a service template can be performed only at a time where the constraints defined by the service template are identifiable and/or the service database is in a temporally static condition.

In the aforementioned selection 114a, 114b, 114c of the concrete services 108a, 108f and 108h out of the candidate sets 112a, 112b and 112c, the selection of the respective services for the entirety of the service templates, i.e. for all of the three service templates 102a, 102b, 102c, has been taken into account for calculating the composition cost.

In contrast hereto, FIG. 2 illustrates the selection of concrete services out of the candidate sets 112a, 112b and 112c by taking into account for the composition cost only a subset of the entirety of service templates. It should be mentioned that in FIG. 2 the skeleton 100, the further data 104, the service templates 102a, 102b, 102c and the individual services 108a, 108b, 108c, 108e, 108f, 108g, 108h and 108i are identical to the respective elements of FIG. 1. However, as mentioned, for calculating the composition cost in a selection process 214a, only a first subset 216a of the service templates 102a, 102b, 102c is taken into account for calculating the composition cost. The first subset 216a comprises the first service template 102a and the second service template 102b. That means, for selecting a service for the first service template 102a, the composition cost for composing the composite service is calculated by taking into account the first service template 102a and the second service template 102b. Hence, without taking into account the third service template 102c, according to the predetermined metric which in the exemplary embodiment is the same as used for the selection processes 114a, 114b and 114c of FIG. 1, service 108b is selected (indicated at 214a) to be executed in place of the first service template 102a.

Then, for selecting a service out of the second candidate set 112b for the second service template 112b, the composition cost for composing the composite service is calculated by taking into account the selected services for a second subset 216b of the entirety of service templates 102a, 102b, 102c. In the exemplary case shown in FIG. 2, the second subset 216b of service templates plates includes the second service template 102b and the third service template 102c. On this basis, respective selection processes 214b and 214c result in the services 108f and 108i being selected for the second service template 102b and for the third service template 102c, respectively.

It should be understood that the skeleton 100, the candidate sets 112a, 112b, 112c, the subsets 216a, 216b and the other elements illustrated in FIG. 1 and FIG. 2 are shown only for illustrative purposes. It should further be understood that the number and the configuration of the respective elements can be changed while still being in accordance with embodiments of the herein disclosed subject-matter. For example, the number of service templates which are taken into account for calculating the composition cost for composing the composite service may be different from two and may be different for each service template under consideration. For example, according to another embodiment, for selecting a service for the first service template 102a, the first and the second service template 102a, 102b may be taken into account for calculating the composition cost, for selecting a service for the second service template 102b all three service templates 102a, 102b, 102c may be taken into account for calculating the composition cost, and for selecting a service for the third service template, the last two service templates 102b, 102c may be taken into account for calculating the composition cost. In more general terms, for selecting a service for a certain service template, if available the predecessor template and the successor template are taken into account as subset of the entirety of service templates. However, in other embodiments are also possible. Further, in some embodiments even no specific ordering/scheduling may be defined for the service templates.

While in FIGS. 1 and 2 exemplary embodiments of the herein disclosed subject-matter have been described, it should be understood that numerous possibilities of implementation of these embodiments exist. For example, some of the entities and units involved in the service selection according to the herein disclosed subject-matter may be located on different network nodes of a communication network, and in particular of a telecommunication network. However, according to other embodiments all entities and units may be located on the same network node or in the same device. In this sense, aspects and embodiments of the herein disclosed subject-matter are applicable to any service composition or program execution system where the constituent services or functions are bound at runtime, e.g. using a late binding approach well-known in service-oriented architectures (SOAs) and some programming languages like Smalltalk or Objective-C.

In the following, embodiments of a more general description of the cost determination/estimation are described. According to an embodiment, selection of concrete services whose selection provides more benefits should have smaller cost. Overall cost estimate may take into account any characteristics relevant for a given metric, exemplary embodiments of which are described hereinafter, e.g. performance, traffic, memory consumption, latency, co-location factor.

In a general embodiment:

Let S be a set of all composition step descriptions.

Let n be a total number of composition steps.

Let STEPi denote a description of a specific composition step I (1<=i<=n).

Let CANDIDATESi be a set of Service Candidates for step i

Let Ctx be a current execution context

Let SERVICEi∈CANDIDATESi be one of the services candidates for step i.

Then every combination COMBINATION of possible service selections for the whole composition is represented by a tuple

(SERVICE1, . . . , SERVICEn), where SERVICEi∈CANDIDATESi for ∀i∈1 . . . n

Let COMBINATIONS be a set of all possible combinations, i.e.:

COMBINATIONS={(SERVICE1, . . . , SERVICEn)|SERVICEi∈CANDIDATESi for ∀i∈1 . . . n}

Cost function is then defined as a function that computes, based on current context and a combination representing possible service selections for the composition, the estimated cost of the composition, where such services selection decisions are taken:

COST: Ctx×COMBINATION->Composition Cost

In the following, some exemplary embodiments of cost functions and metrics are described. However, it should be noted that these embodiments are only provided for illustrative purposes and that any other cost functions and metrics may be employed.

In one embodiment, e.g. where an IP multimedia subsystem (IMS) is used and services are services running in the network or on the mobile devices, the cost function should result in a lower cost if multiple services are co-located on the same node/device. For example, the cost may be the lower, the more services are located on the same node/device. This is an example of taking into account the co-location factor. This allows for reducing the amount of traffic for exchanging data between co-located services and also reduces the overhead for service invocations of co-located services, as they these are now local invocations instead of global invocations.

In another embodiment, the traffic metric can be used. It should produce a lower cost for combinations, where less data is supposed to be exchanged between the selected services (and composition engine). The information about the supposed data to be exchanged can be derived from the description of a composition (i.e. from some sort of data dependencies analysis) and from service descriptions saved in a service database.

In the further embodiment, the latency metric can be used. It should produce a lower cost for combinations, where a smaller latency is expected for the overall composition. The information about the expected latency can be derived from the different sources, e.g. from service execution statistics, from service descriptions, from the fact that latency of a local service invocation is (usually) smaller than the latency of a remote service invocation, etc. When such a metric is applied, the metric would result in preferring combinations that use low-latency services and/or those ones, where multiple services are co-located so that local invocations can be used.

In a further embodiment, the energy efficiency metric can be used. It should produce a lower cost for combinations, where smaller energy consumption is expected for the overall composition (which can be very interesting for mobile or embedded devices). The information about the expected energy consumption can be derived e.g. from service execution statistics (implicit analysis of energy consumption), from service descriptions (explicit information about energy consumption may be part of service description), from the estimates on data-traffic between and inside involved nodes and estimates of energy consumption related to it (e.g. energy required for transmitting and processing a certain amount of data), etc.

Once all cost estimates are available, the system tries to find a combination with a minimal cost. To this end, any appropriate algorithm may be used. Such algorithms e.g. algorithms for finding combination tuples which are minimized with respect to a specific metric are well known in the art and are not discussed in further detail. It should be noted that it is not strictly necessary to first compute cost estimates for all combinations and only then look for a minimum. Any other more advanced algorithms for finding a minimum can be used.

In some embodiments, it is not required or not possible to find a global minimum. Nevertheless, at least a locally minimal solution can be taken. This solution is in almost any case better than a random solution taken by the current service composition system when it lacks any information about context and interdependencies between service selections at different steps.

Enforcing the optimal solution during service composition may be performed as follows: According to an illustrative embodiment, if the system has found a service selections combination with a minimal cost, then service selection process should take exactly those decisions that correspond to the service selections represented by this combination. Further, according to an embodiment, if a certain step is not covered by the found minimal combination, the system is free to apply any other policy to pick one service out multiple candidates.

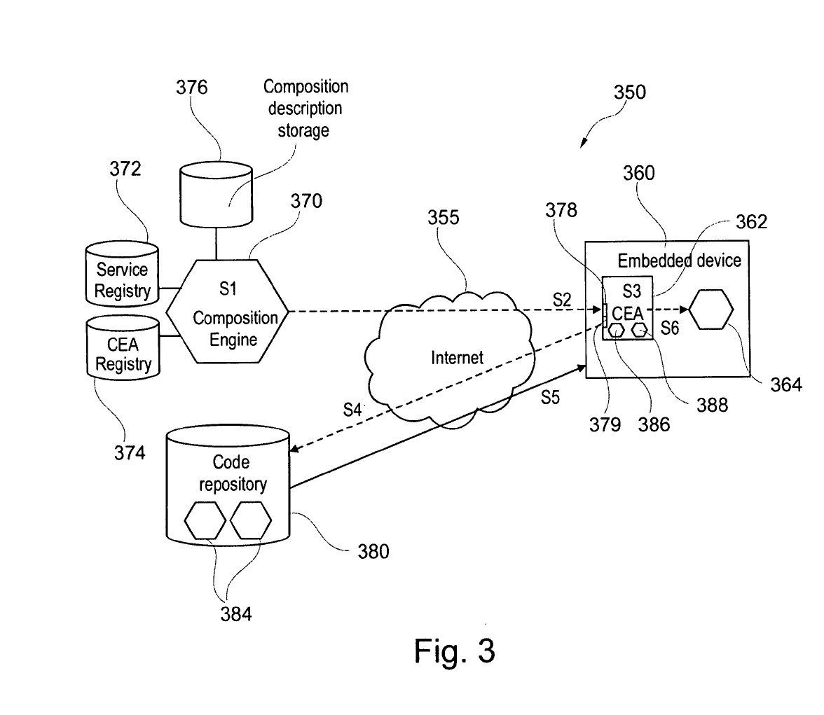

FIG. 3 shows a telecommunication network 350, which is adapted to perform a service selection method according to embodiments of the herein disclosed subject-matter.

The network node(s) on which entities and units of the herein disclosed subject matter reside may be any end-user device or may be, according to another embodiment, any central entity of the telecommunication network, e.g. an entity is responsible for the orchestration of composed services. The network node may comprise a Business Process Execution Language (BPEL) engine. Within a clustered configuration a BPEL engine may provide for instance a distributed setup by delegating the execution of some services to external network entities.

The telecommunication network 350 comprises an embedded network device 360. The embedded network device 360, which may be any mobile device and which may be denominated as a user equipment (UE), is connected via a wireless radio connection to a core network 355, which is in the illustrated embodiment the internet.

The embedded network device 360 comprises a composition execution agent (CEA) 362 and data processing and storage means 364. Further the telecommunication network 350 comprises a service composition node 370 which is also denominated as a composition engine (CE). The service composition node 370 is connected via the internet 355 to the mobile embedded network device 360. Further, the service composition node 370 is connected to a service registry 372, to a composition execution agent (CEA) registry 374 and to a composition description storage 376. Further, the telecommunication network 350 comprises a code storage node 380, which is also denominated a code repository (CR). The code storage node 380 is equipped with data processing and storage means 384.

In the following, a composite service execution by the embedded network device 360 is described, wherein in preparation of the composite service execution a service selection according to the herein disclosed subject-matter is performed.

In composite service description storage 376 a composite service description is stored which includes at least two service templates. Each service template defines at least one constraint for a server, wherein the service is to be executed in place of the service template to thereby constitute part of the composite service. For example, the composite service description may be provided by the composition storage 376 in the form of an application skeleton. Based on the application skeleton, the service composition node 370 evaluates a description of a service template. The description of the service template comprises at least one constraint for the service which is to be executed in place of the service template. Hence the constraints are indicative of the service which is to be executed and which CEA 362 should execute them.

The CEA registry 274 contains the list of available CEAs and the services that they can run. The service registry 372 contains a list of available services. According to an embodiment, the service composition node 370 uses information from the service registry 372 and from the CEA registry 374.

In case that several CEAs match the given constraints of the service templates, one CEA 362 is selected arbitrarily or according to some predetermined cost function, e.g. a predetermined cost function as disclosed herein.

The embedded device 360 comprises a receive unit 378 for receiving, from the composite service description storage 376 a composite service description which includes at least two service templates. For example, in the method illustrated in FIG. 3, in a second step indicated in FIG. 3 with “S2”, the service composition engine 370 sends to the selected CEA 362 a service execution request containing an implicit reference to the services that should be executed in place of the service templates. Instead of sending a direct link, name or unique identifier of the service to be executed, the service composition engine 370 sends a set of constraints corresponding to the service templates which is received by the receive unit 378. The service templates form the (partial) composite service description. Optionally, together with the set of constraints or in a separate message, the service composition node 370 could also send several descriptions or direct links to codes of services that are known to match these constraints so that the CEA 362 could choose among them if it does not know them already. In a third step, which is indicated in FIG. 3 with “S3”, the CEA 362 evaluates the constraints of the service templates received with the service execution request and merges these constraints with local constraints of the embedded network device 360. Such local constraints may be for instance the platform type of the device 370, the availability of resources and/or various cost factors.

The CEA 362 comprises a candidate selection unit 386 in accordance with the herein disclosed subject-matter, for selecting from a service database, here in the form of the service registry 372, for each service template a corresponding candidate set comprising at least one service matching the at least one constraint of the respective service template. Further, the CEA 362 comprises a service selection unit 388 for selecting from a corresponding candidate set, for each of the at least two service templates, one service so as to provide, based on a predetermined cost metric, for a reduced composition cost. The selection of candidate sets and the selection of services out of the candidate sets is indicated at S3 in FIG. 1.

If the CEA 362 already has the selected services installed, it executes them as requested. If the CEA 362 does not have the services or all of the selected services installed, then it tries to download the missing selected services as described in the following steps. In the fourth step, which is indicated in FIG. 3 with “S4”, the CEA 362 sends by means of a sending unit 379 a download request to the code storage node 380, asking the code storage node 380 for the code of the missing selected services.

In a fifth step, which is indicated in FIG. 3 with “S5”, the code storage node 380 sends the code of the requested service to the CEA 362. In this respect it should be mentioned that the term “code” should be understood in a broad sense. Code can be for instance some executable program code, but in addition or instead of an executable program code, the CEA 362 could also receive from the code storage node 380 configuration options or other data that is/are necessary for the execution of the selected services.

In a sixth step, which is indicated in FIG. 3 with “S6”, the downloaded code is installed locally and then executed on the data processing and storage means 364.

It should be understood that the implementation of embodiments of the herein disclosed subject matter, which is shown in FIG. 3 is only exemplary. Other implementation may differ completely or only slightly from the communication system 350 in FIG. 3. For example in other embodiments, some or all of the entities shown in FIG. 3, e.g. the composition engine 370 and the code repository 384, may be located on a single network node.

According to embodiments of the herein disclosed subject-matter, any component involved in the service selection method according to the herein disclosed subject-matter, e.g. any element or unit of the service entity disclosed herein, is provided in the form of respective computer program products which enable a processor to provide the functionality of the respective elements or units as disclosed herein. According to other embodiments, any such element/unit is provided in hardware. According to other-mixed-embodiments, some of these elements/units are provided in software while other elements/units are provided in hardware.

It should be noted that the term “comprising” does not exclude other elements or steps and that “a” or “an” does not exclude a plurality. Also elements and features described in association with different embodiments may be combined. It should also be noted that reference signs in the claims should not be construed as limiting the scope of the claims.

In order to recapitulate the above-described embodiments of the herein disclosed subject-matter one can state:

It is described a concept for a service selection of at least two services of a composite service wherein a composite service description of the composite service includes at least two service templates, each of which defines at least one constraint for a service wherein the service is to be executed in place of the service template to thereby constitute part of the composite service. From service database there is selected for each service template a corresponding candidate set comprising at least one service matching the at least one constraint of the service template. Subsequently or at least partially simultaneously for each of the at least two service templates, from the corresponding candidate set one service is selected so as to provide, based on a predetermined cost metric, for a reduced composition cost. The predetermined cost metric may include a latency metric, an energy efficiency metric, a co-location metric or a traffic metric, etc.

Embodiments of the herein disclosed subject matter propose a method for minimizing costs of compositions according to a given metric (performance, traffic, latency, co-location factor, etc). As some of these embodiments minimize or at least reduce the estimated cost of utilizing e.g. a given system resource, these embodiments would lead to real cost savings in the use of service composition technology and thus makes service composition technology even more attractive.

Although embodiments of the herein disclosed subject matter have been discussed in the context of a telecommunication network, the herein disclosed subject matter is also applicable for a broader field of systems, where central nodes orchestrate execution of other services (e.g. BPEL engines, workflow engines, distributed systems with central control nodes).

### LIST OF REFERENCE SIGNS

100 composite service description/skeleton
102a,b,c service template
104 further data
106 service data base
108a-j service
110a,b,c selection of candidate set
112a,b,c candidate set
114a,b,c selection of service for service template
214a,b,c selection of service for service template
216a,b subset of entirety of service templates of the skeleton
350 telecommunication network
355 core network/Internet
360 network device/embedded (network) device/mobile device/user equipment (UE)
362 composition execution agent (CEA)
364 data processing and storage means
370 service composition node/composition engine (CE)
372 service registry
374 CEA registry
376 composition description storage
378 receiving unit for receiving composite service description
379 sending unit
380 code storage node/code repository (CR)
384 data processing and storage means
386 candidate selection unit
388 service selection unit

1-15. (canceled)

16. A method for service selection of at least two services of a composite service, the method comprising:
providing a composite service description including at least two service templates, each service template defining at least one constraint for a service, wherein the service is to be executed in place of the service template to thereby constitute part of the composite service;
selecting, from a service database and for each service template, a corresponding candidate set comprising at least one service matching the at least one constraint of the service template;
for each of the at least two service templates, selecting one service from the corresponding candidate set so as to provide the composite service for a reduced composition cost based on a predetermined cost metric.

17. The method of claim 16 wherein the selecting the one service comprises selecting the one service from the corresponding candidate set so as to provide a minimum of the composition cost for composing the composite service.

18. The method of claim 16 wherein the composition cost for composing the composite service is calculated by taking into account the selected services for the entirety of service templates of the composite service description.

19. The method of claim 16 wherein the composition cost for composing the composite service is calculated by taking into account the selected services for a subset of the entirety of service templates of the composite service description.

20. The method of claim 16 wherein the selecting the corresponding candidate set is performed before invocation of composing the composite service.

21. The method of claim 16 wherein the selecting the corresponding candidate set is performed, at least in part, at or after invocation of composing the composite service.

22. The method of claim 16:
wherein the predetermined metric comprises a latency metric according to which the cost of composing of selected services is dependent on a latency for composing of the selected services of the at least two service templates;
wherein the latency is defined as time delay between invocation of composing the services of the at least two service templates and the earliest possible execution of the composite service.

23. The method of claim 16 wherein the predetermined metric comprises an energy efficiency metric such that cost is proportional to energy consumption of the selected services of the at least two service templates.

24. The method of claim 16 wherein the predetermined metric comprises a co-location metric such that cost is dependent on a number of the selected services which are located on the same network node.

25. The method of claim 16 wherein the predetermined metric comprises a traffic metric such that cost is dependent on an amount of data that is exchanged between different communication network nodes for composing the services of the at least two service templates.

26. The method of claim 16:
wherein the at least two service templates include a first service template and a second service template; and
wherein the selecting one service from the corresponding candidate set comprises selecting a service for the first service template depending on a selection of a service for the second service template;
wherein the selected service for the second service template is scheduled for execution after the selected service of the first service template.

27. A selection entity for service selection of at least two services of a composite service, the selection entity comprising:
a receiving unit configured to receive, from a composite service description storage, a composite service description which includes at least two service templates, each service template defining at least one constraint for a service, wherein the service is to be executed in place of the service template to thereby constitute part of the composite service;
a candidate selection unit configured to select, from a service data base and for each service template, a corresponding candidate set comprising at least one service matching the at least one constraint of the service template;
a service selection unit configured to select from a corresponding candidate set, for each of the at least two service templates, one service so as to provide the composite service for a reduced composition cost based on a predetermined cost metric.

28. The selection entity of claim 27:
wherein the selection entity is a network node of a communication network;
further comprising a sending unit for sending one of the following to a further network node of the communication network:
the services selected from the candidate sets;
identifiers of the services selected from the candidate sets.

29. A computer program product stored in a non-transitory computer readable medium for controlling service selection of at least two services of a composite service, the computer program product comprising software instructions which, when run on a data processor, causes the data processor to:
provide a composite service description including at least two service templates, each service template defining at least one constraint for a service, wherein the service is to be executed in place of the service template to thereby constitute part of the composite service;
select, from a service database and for each service template, a corresponding candidate set comprising at least one service matching the at least one constraint of the service template;
for each of the at least two service templates, select one service from the corresponding candidate set so as to provide the composite service for a reduced composition cost based on a predetermined cost metric.
